(19) United States
(12) Patent Application Publication
(10) Pub. No.: US 2022/0228703 A1
(43) Pub. Date: Jul. 21, 2022

(54) OBJECT SUPPORT STRUCTURE

(71) Applicant: SENSEAGE CO., LTD., TAIPEI CITY (TW)

(72) Inventor: Ben-Tien Lin, New Taipei City (TW)

(21) Appl. No.: 17/454,380

(22) Filed: Nov. 10, 2021

(30) Foreign Application Priority Data
Jan. 15, 2021 (CN) 202120099941.0

(51) Int. Cl. F16M 13/00; F16M 11/38

(52) U.S. Cl. CPC F16M 13/00; F16M 11/38

(57) ABSTRACT

An object support structure includes: a bendable sheet having a first part and a second part, a hole at the middle of the bendable sheet, and a first folding line and a second folding line between the first and second parts, so that the first and second parts can be folded against each other; a central support plate in the hole and having a third part and a fourth part, and a third folding line between the third and fourth parts, wherein the central support plate can be bent with respect to the bendable sheet, and an end of the central support plate is connected to the second part, and the central support plate has a first folding line and a second folding line; and a bottom plate having a side connected to the bendable sheet which can be bent with respect to the bottom plate.

### FIELD OF THE INVENTION

The present invention relates to the technical field of support devices, and more particularly to an object support structure for supporting an object such as a mobile device.

### BACKGROUND OF THE INVENTION

Nowadays, the handheld mobile devices and computer devices such as mobile phones, tablet PCs, etc. with tremendous convenience have become an indispensable part of our life. However, when we use these mobile devices and computer devices to watch videos or check data for a long time, users need to hold the mobile devices and computer devices to do so, and thus causing inconvenience. In view of the aforementioned drawback, the inventor of the present invention based on years of experience in the related industry to conduct research and experiment, and finally developed an object support structure in accordance with the present invention to overcome the aforementioned drawback of the prior art.

### SUMMARY OF THE INVENTION

It is a primary objective of the present invention to overcome the aforementioned drawbacks of the prior art by providing an object support structure in accordance with the present invention.

To achieve the aforementioned and other objectives, the present invention discloses an object support structure, comprising: a first part and a second part, a hole formed at the middle of the bendable sheet, and a first folding line and a second folding line formed between the first part and the second part, so that the first part and the second part can be bent against each other; a central support plate, installed at the hole, and having a third part and a fourth part, and a third folding line formed between the third part and the fourth part, wherein the central support plate can form a bent state with respect to the bendable sheet, and an end of the central support plate is coupled to the second part; and a bottom plate, coupled to an end of the bendable sheet, and the bendable sheet can form a bent state with respect to the bottom plate, characterized in that: the fourth part is coupled with the second part by a fourth folding line, and the third part is not coupled to the bendable sheet, and at least a portion of the third part is attached to the bottom plate, and when the object support structure is bent, the second part and the fourth part are attached with each other.

In an embodiment, the bottom plate is attached to a side of an object by a permanent fixing method or a non-permanent fixing method.

In an embodiment, when the object support structure is bent, the first folding line and the second folding line form a contact point abutting against a plane, so as to lift up the object relative to the plane; or when the object support structure is bent, the first part acts as a contact surface abutting against a plane, so as to erect the object relative to the plane.

In an embodiment, the third part and the bottom plate are attached to each other by a permanent fixing method or a non-permanent fixing method.

In an embodiment, when the bendable sheet forms a bent state with respect to the bottom plate, the first part and the second part are upheaved relative to the bottom plate.

In an embodiment, the second part and the fourth part have a magnetic property.

### BRIEF DESCRIPTION OF THE DRAWINGS

FIG. 1 is a perspective view of a first embodiment of the present invention;

FIG. 2 is a first schematic view of the present invention;

FIG. 3 is a second schematic view of the present invention;

FIG. 4 is a third schematic view of the present invention;

FIG. 5 is a fourth schematic view of the present invention;

FIG. 6 is a schematic view of a first using status of the present invention;

FIG. 7 is a schematic view of a second using status of the present invention; and

FIG. 8 is a schematic view of a third using status of the present invention.

### DESCRIPTION OF THE PREFERRED EMBODIMENTS

To make it easier for people having ordinary skill in the art to understand the technical contents of this invention, the specification accompanied by the drawings is described as follows.

In the present invention, the non-permanent fixing method refers to a method of connecting any two objects by magnetism, Velcro tape, detachable snap mechanism, or reusable adhesive, etc., and the two object can be disconnected at any time, and the permanent fixing method refers to connecting any two objects by non-reusable adhesive, sewing, nailing, etc.

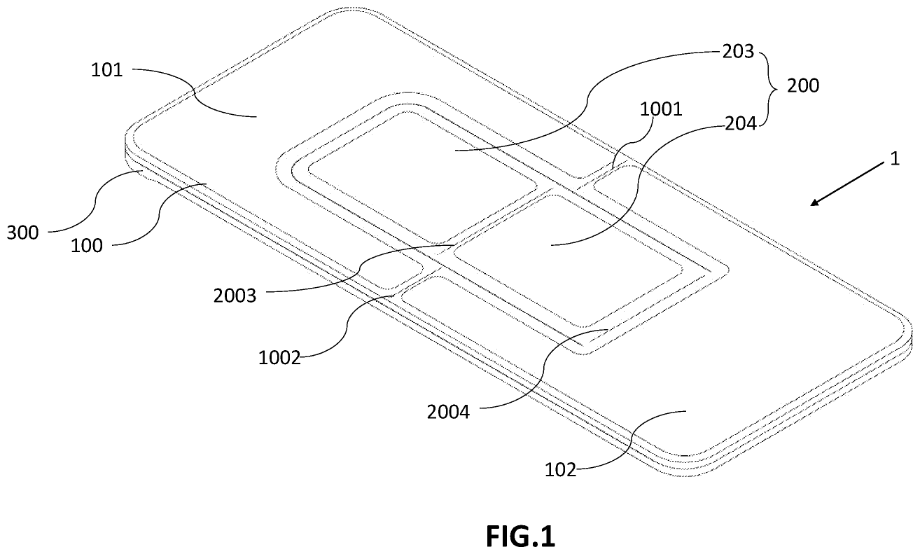

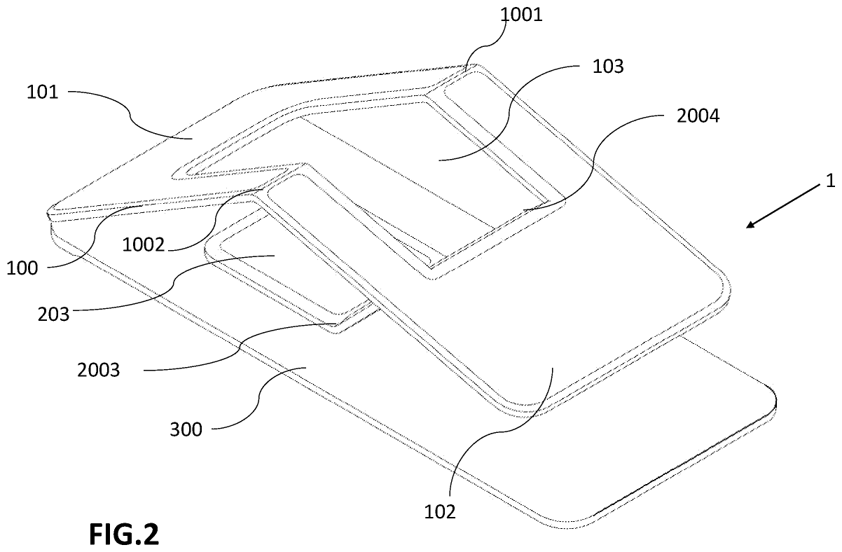

With reference to FIGS. 1 to 5 for the perspective view and first to fourth schematic views of the present invention respectively, an object support structure as shown in FIGS. 1 and 2 comprises: a bendable sheet 100, including a first part 101 and a second part 102, a hole 103 formed at the middle of the bendable sheet 100, and a first folding line 1001 and a second folding line 1002 formed between the first part 101 and the second part 102, so that the first part 101 and the second part 102 can be bent against each other; a central support plate 200, installed in the hole 103, and having a third part 203 and a fourth part 204, and a third folding line 2003 formed between the third part 203 and the fourth part 204. In FIG. 2, the central support plate 200 can form a bent state with respect to the bendable sheet 100, and an end of the central support plate 200 is connected to the second part 102. The object support structure further comprises a bottom plate 300, and an end of the bendable sheet 100 is connected to a side of the bottom plate 300. During use, the bendable sheet 100 can form a bent state with respect to the bottom plate 300. In the invention, the bendable sheet 100 is configured to be bent in a direction towards the bottom plate 300, so that after the bending, the first part 101 and the second part 102 can be upheaved relative to the bottom plate 300 as shown in FIG. 2.

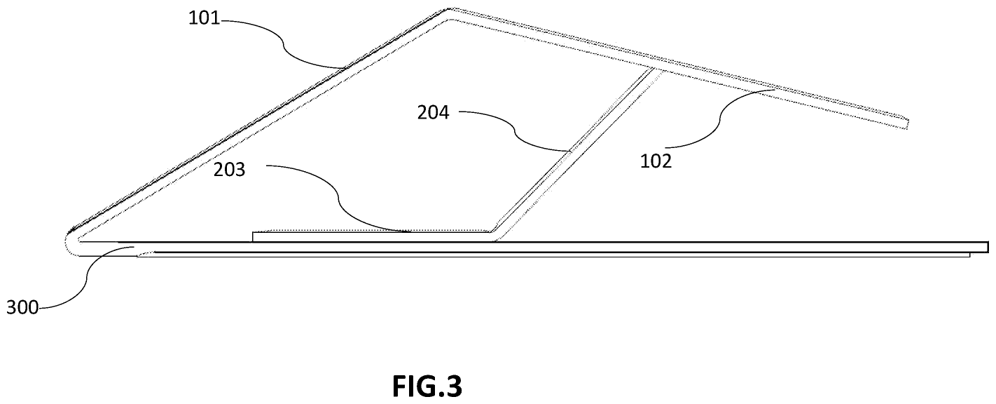

In addition to FIGS. 1 and 2, please further refer to FIG. 3. Unlike the prior art, the present invention has the fourth part 204 and the second part 102 connected to each other by a fourth folding line 2004, but the third part 203 is not connected to the bendable sheet 100. In an embodiment, at least a portion or the whole of the third part 203 is attached to the bottom plate 300. The third part 203 and the bottom plate 300 can be attached to each other by a permanent fixing method or a non-permanent fixing method. When the object support structure is bent, the second part is attached to the fourth part 204 in a direction towards the bottom plate 300 and the fourth part 204 by the non-permanent fixing method.

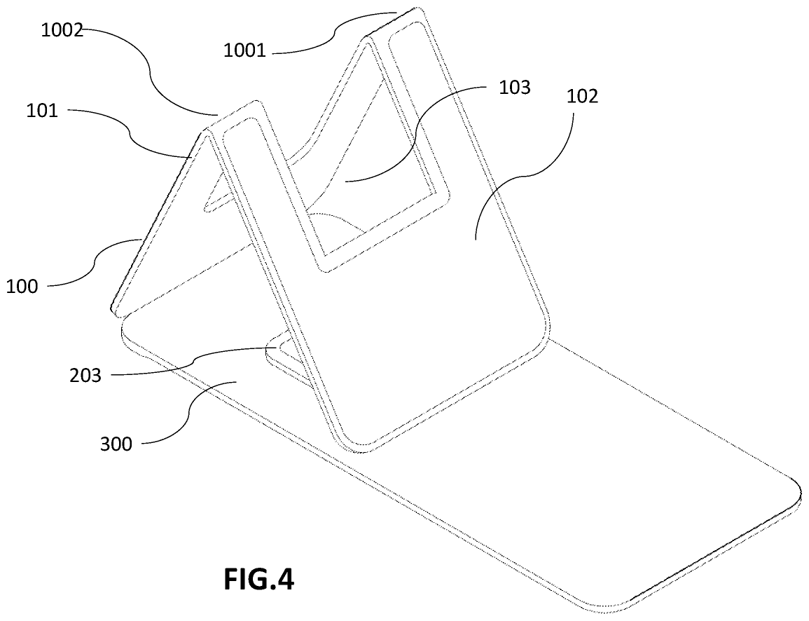

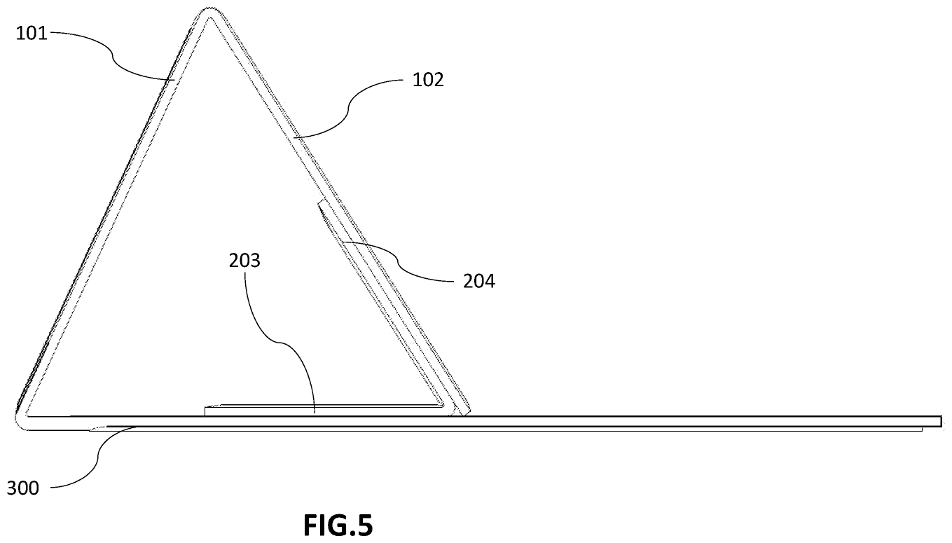

With reference to FIGS. 4 and 5 for the perspective view and the side view of the present invention after the bending is completed respectively, the first part 101, the second part 102, and the bottom plate 300 are configured into a triangular shape.

In the present invention, a user can attach a side of the bottom plate 300 to a side of an object by the permanent fixing method or non-permanent fixing method. The bendable sheet 100 and the bottom plate 300 can be connected to each other by glues, magnetic forces, or other permanent fixing method or non-permanent fixing method. In an embodiment, the bendable sheet 100 and the bottom plate 300 can be integrally formed into one piece.

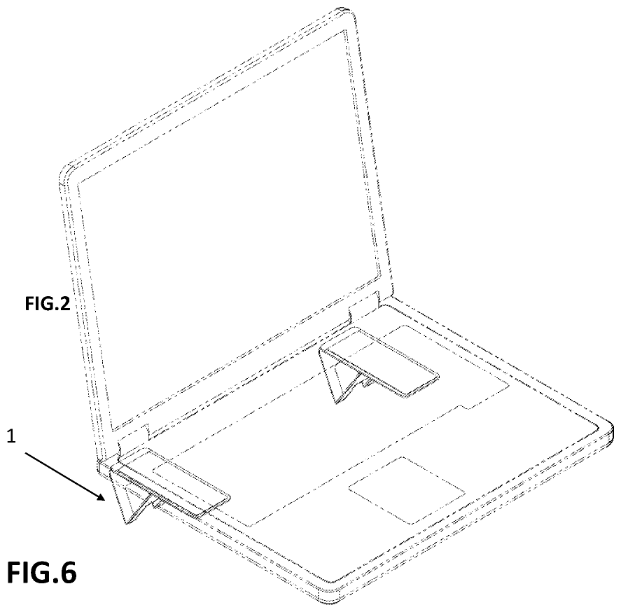

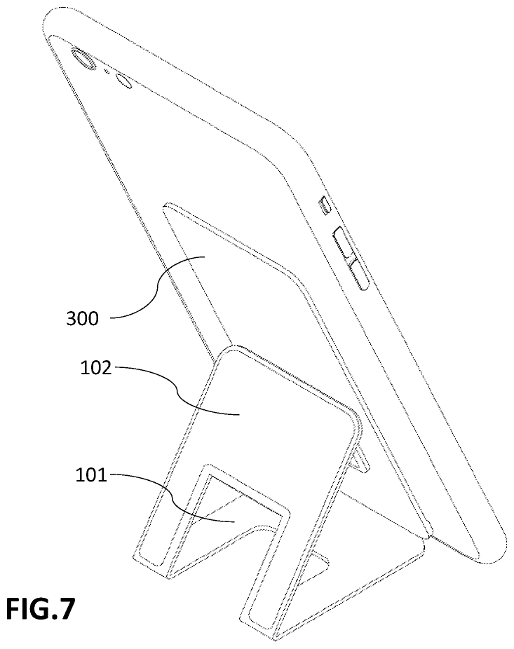

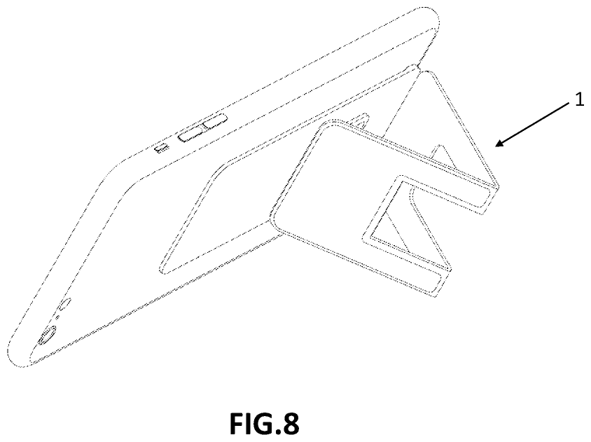

In an embodiment, the present invention can use a mobile device such as a mobile phone, a notebook or a tablet PC. In FIGS. 6-8, users can install a plurality of object support structures 1 on a side of the notebook or tablet PC. When the object support structure 1 is bent, the first folding line 1001 and the second folding line 1002 form a contact point abutting against a plane, so as to lift up the notebook or tablet PC relative to the plane. In an embodiment as shown in FIG. 7, the users can install an object support structure 1 on a side of the mobile phone. When the object support structure 1 is bent, the first part 101 acts as a contact surface abutting against a plane, so as to erect the mobile phone relative to the plane. Therefore, the present invention can simultaneously use the mobile phone, notebook or tablet PC. Due to the special bending method of the object support structure 1, a multiple of functions are possible. Compared to the prior art, the present invention is more convenient.

In an embodiment, the second part and the fourth part have the magnetic property, so that the object support structure 1 in the folded state can be fixed.

While the present invention is described in some detail hereinbelow with reference to certain illustrated embodiments, it is to be understood that there is no intent to limit the invention to those embodiments. On the contrary, the aim is to cover all modifications, alternatives and equivalents falling within the spirit and scope of the invention as defined by the appended claims.

What is claimed is:

1. An object support structure, comprising:
a bendable sheet, including a first part and a second part, a hole formed at the middle of the bendable sheet, and a first folding line and a second folding line formed between the first part and the second part, so that the first part and the second part can be bent against each other;
a central support plate, installed at the hole, and having a third part and a fourth part, and a third folding line formed between the third part and the fourth part, wherein the central support plate can form a bent state with respect to the bendable sheet, and an end of the central support plate is coupled to the second part; and a bottom plate, coupled to an end of the bendable sheet, and the bendable sheet can form a bent state with respect to the bottom plate, characterized in that: the fourth part is coupled with the second part by a fourth folding line, and the third part is not coupled to the bendable sheet, and at least a portion of the third part is attached to the bottom plate, and when the object support structure is bent, the second part and the fourth part are attached with each other.

2. The object support structure according to claim 1, wherein the bottom plate is attached to a side of an object by a permanent fixing method or a non-permanent fixing method.

3. The object support structure according to claim 2, wherein when the object support structure is bent, the first folding line and the second folding line form a contact point abutting against a plane, so as to lift up the object relative to the plane.

4. The object support structure according to claim 2, wherein when the object support structure is bent, the first part acts as a contact surface abutting against a plane, so as to erect the object relative to the plane.

5. The object support structure according to claim 1, wherein the third part and the bottom plate are attached to each other by a permanent fixing method or a non-permanent fixing method.

6. The object support structure according to claim 1, wherein when the bendable sheet forms a bent state with respect to the bottom plate, the first part and the second part are upheaved relative to the bottom plate.

7. The object support structure according to claim 1, wherein the second part and the fourth part have a magnetic property.
